(19) United States
(12) Patent Application Publication
(10) Pub. No.: US 2021/0295127 A1
(43) Pub. Date: Sep. 23, 2021

(54) PLASTIC CARD PROCESSING EQUIPMENT WITH BIOMETRIC CARD SENSOR TESTING

(71) Applicant: Entrust Corporation, Shakopee, MN (US)

(72) Inventor: Ryan Boudreau, Shakopee, MN (US)

(21) Appl. No.: 17/204,292

(22) Filed: Mar. 17, 2021

Related U.S. Application Data
(60) Provisional application No. 62/990,703, filed on Mar. 17, 2020.

(51) Int. Cl. G06K 19/07; B42D 25/313; B42D 25/305; B42D 25/425; B42D 25/435; G06Q 20/40

(52) U.S. Cl. CPC G06K 19/0718; B42D 25/313; G06Q 20/40145; B42D 25/425; B42D 25/435; B42D 25/305

(57) ABSTRACT

Plastic card processing equipment that provide the ability to test the functionality of a biometric sensor on a plastic card to verify that the biometric sensor is working properly prior to being issued to a card holder. The test can be performed while the plastic card is within the plastic card processing equipment, before or after any processing occurs on the plastic card.

### FIELD

This disclosure relates to plastic cards including, but not limited to, financial (e.g., credit, debit, or the like) cards, access cards, driver's licenses, national identification cards, business identification cards, gift cards, and other plastic cards that include one or more biometric sensors incorporated into the plastic cards, and to plastic card processing equipment that can test the functionality of the biometric sensors on the plastic cards during processing of the plastic cards in plastic card processing equipment.

### BACKGROUND

A smartcard having a fingerprint sensor on the smartcard is known from US 20190377855 and US 20190102662. The fingerprint sensor adds additional security to the use of the smartcard, for example by requiring reading of the card holder's fingerprint by the fingerprint sensor in order for the smartcard to be used, for example to make a purchase.

### SUMMARY

Plastic card processing equipment and methods are described that allow the ability to test the functionality of a biometric sensor on a plastic card to verify that the biometric sensor is working properly prior to being issued to a card holder. The test can be performed while the plastic card is within the plastic card processing equipment, before or after any processing occurs on the plastic card.

Power for operating the biometric sensor can be provided by any suitable power source on the plastic card or in the plastic card processing system. In one embodiment, the plastic card can include an integrated circuit chip that is electrically connected to the biometric sensor and that provides power to the biometric sensor for the testing. In one embodiment, the integrated circuit chip may not be programmed with any personal data, including data representative of biometric data of the intended card holder, at the time of testing the biometric sensor. In another embodiment, at the time of testing the biometric sensor the integrated circuit chip may be programmed with some personal data of the intended card holder which may or may not include data representative of biometric data of the intended card holder which during use of the plastic card is used to compare with a biometric feature sensed/detected by the biometric sensor.

A plastic card with a biometric sensor described herein can be any type of plastic card that is issued to a card holder. The plastic card may include personal data that is personal to the intended card holder, including a personal account number, the card holder's name, a photograph of the intended card holder, an address, an expiration date, and other personal data known in the art. The plastic card may also include non-personal data such as a name and/or logo of the card issuer and graphical elements. Examples of plastic cards include, but are not limited to, financial (e.g., credit, debit, or the like) cards, access cards, driver's licenses, national identification cards, business identification cards, gift cards, and other plastic cards.

In one embodiment, a method described herein includes inputting a plastic card into a plastic card processing system, where the plastic card has at least one biometric sensor. In some embodiments, the plastic card can include two or more biometric sensors, or a single biometric sensor could be used to sense/detect more than one biometric feature. With the plastic card in the plastic card processing system, the functionality of the at least one biometric sensor is tested. In one embodiment, the functionality testing can be performed after the plastic card is processed or personalized in the processing system which is useful in the event that the processing somehow damages operation of the biometric sensor. In another embodiment, the functionality testing can be performed before the plastic card is processed or personalized in the processing system. If the biometric sensor is not functioning properly, the plastic card can be discarded by the processing system, eliminating wasted processing on the plastic card with the improperly functioning biometric sensor. If the biometric is determined to be functioning properly, the card can be further processed in the processing system. In other embodiments, the functionality testing can be performed twice, once before processing/personalization and again after processing/personalization.

In another embodiment, a method described herein includes inputting a plastic card into a plastic card processing system, where the plastic card has at least one biometric sensor and at least one integrated circuit chip that is electrically connected to the at least one biometric sensor. With the plastic card in the plastic card processing system, the functionality of the at least one biometric sensor is tested using electrical power supplied from the at least one integrated circuit chip. After testing the functionality of the at least one biometric sensor, the plastic card can then be transported to an output or to a reject hopper depending upon the results of the functionality testing. In one embodiment, the functionality of the at least one biometric sensor and the functionality of the at least one integrated circuit can be tested at the same time

A plastic card processing system described herein can include a biometric sensor testing device that is configured to test functionality of at least one biometric sensor on a plastic card in the plastic card processing system. The system may also include a card input that is configured to hold a plurality of the plastic cards and feed the plastic cards one by one into the plastic card processing system, where each plastic card has at least one biometric sensor. The system can further include a card output that is configured to hold a plurality of processed plastic cards, and one or more card transport mechanisms that interconnect the card input, the biometric sensor testing device, and the card output.

### DRAWINGS

FIG. 1 is a plan view of a surface of a plastic card described herein.

FIG. 2 is a schematic depiction of one embodiment of a card processing system described herein that is configured to perform functionality testing of a biometric sensor on a plastic card.

FIG. 3 is a schematic depiction of another embodiment of a card processing system described herein that is configured to perform functionality testing of a biometric sensor on a plastic card.

FIG. 4 depicts one embodiment of a method of testing the functionality of a biometric sensor on a plastic card described herein.

FIG. 5 depicts another embodiment of a method of testing the functionality of a biometric sensor on a plastic card described herein.

FIG. 6 illustrates an example mechanical construction of a biometric sensor testing device.

### DETAILED DESCRIPTION

The following is a description of plastic card processing equipment and methods that allow the ability to test the functionality of a biometric sensor on a plastic card to verify that the biometric sensor is working properly prior to being issued to a card holder. The test can be performed while the plastic card is within the plastic card processing equipment, before or after any processing occurs on the plastic card. The plastic cards described herein may also be referred to as biometric cards, biometric sensor cards, plastic biometric cards, and the like.

As used herein, the term “processing” (or the like) is intended to encompass operations performed on a card that includes operations that result in personalizing the card as well as operations that do not result in personalizing the card. An example of a processing operation that personalizes the card is printing the cardholders name on the card. An example of a processing operation that does not personalize the card is applying a laminate to the card or printing non-cardholder graphics on the card. The term “personalize” is often used in the card industry to refer to cards that undergo both personalization processing operations and non-personalization processing operations.

A card with a biometric sensor described herein can be any type of card that is issued to a card holder. Examples of cards include, but are not limited to, financial (e.g., credit, debit, or the like) cards, access cards, driver's licenses, national identification cards, business identification cards, gift cards, and other cards. The term “plastic cards” as used throughout the specification and claims, unless indicated otherwise, refers to cards of this type where the card substrate can be formed entirely of plastic, formed of a combination of plastic and non-plastic material, or formed mostly or completely of non-plastic materials. In one embodiment, the cards can be sized to comply with ISO/IEC 7810 with dimensions of about 85.60 by about 53.98 millimeters (about 3⅜ in×about 2⅛ in) and rounded corners with a radius of about 2.88-3.48 mm (about ⅛ in).

The biometric sensor can be any type of biometric sensor that can sense or detect a biometric feature including, but not limited to, a fingerprint sensor, an iris sensor, a facial recognition sensor, a voice recognition sensor, or a spectroscopic sensor. In one embodiment, during operational use of the card, the biometric sensor will be used to sense at least one biometric feature of the intended holder of the card which is then compared to stored biometric data of the intended card holder to verify the card holder while the card is being used. The biometric data can be stored on the card, for example in an integrated circuit chip, or the biometric data can be stored away from the card but which is accessible during attempted use of the card to compare with the biometric feature detected from the person presenting the card.

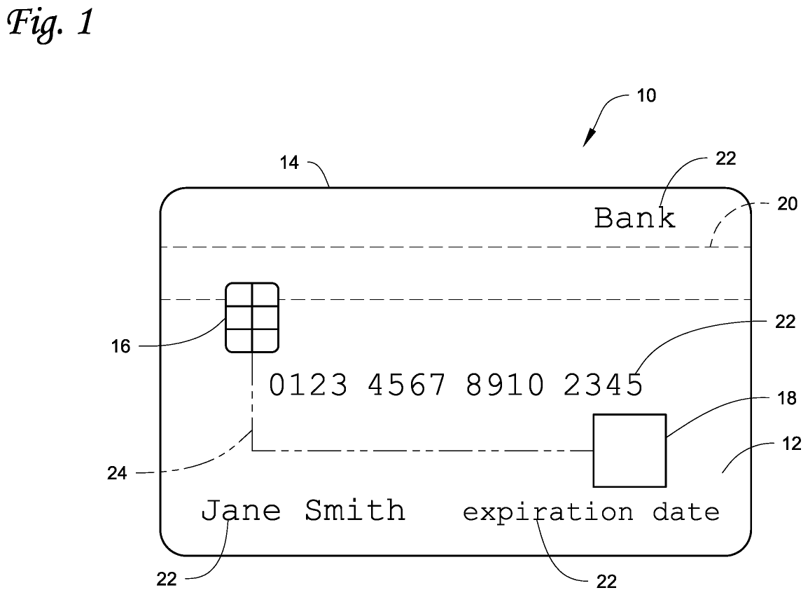

Referring to FIG. 1, an example of a plastic card 10 is illustrated. In this example, the card 10 is shown to include a front surface 12, a rear or back surface (not shown) opposite the front surface 12, and a perimeter edge 14. The card 10 includes at least one integrated circuit chip 16, at least one biometric sensor 18, an optional magnetic stripe 20, and printed data 22.

The integrated circuit chip 16 is known in the art and can include data storage for storing data thereon. The data stored on the chip 16 can ultimately include personal data of the intended card holder such as the cardholder's name, personal account number, biometric data of the cardholder, and other data. The chip 16 can be a contactless chip that is powered by a contactless chip reader through radio frequency induction via an antenna of the chip reader. The chip 16 may also be a contact chip that is intended for direct contact with a contact chip reader which provides power to the chip 16. The chip 16 may be completely embedded within the thickness of the card so that no portion of the chip 16 is exposed, or portions of the chip 16 may be exposed. The construction and operation of both contactless chips and contact chips on cards is well known in the art.

The biometric sensor 18 is located on or in the card 10 at a location that permits the biometric sensor 18 to perform its sensing function. In the illustrated example in FIG. 1, the biometric sensor 18 can be positioned so that the biometric sensor 18 is accessible at the front surface 12 of the card 10. Power for operating the biometric sensor 18 can be supplied from any suitable power source located on the card 10 or not located on the card 10. For example, in the illustrated example of FIG. 1, the biometric sensor 18 is electrically connected to the chip 16 via one or more conductors 24 embedded in the card 10. The conductor(s) 24 are able to direct electrical power from the chip 16 to the biometric sensor 18 for powering operation of the sensor 18. In addition, the conductor(s) 24 or one or more different conductors are able to direct data between the chip 16 and the biometric sensor 18. Alternatively, the chip 16 and the biometric sensor 18 can each be mounted on a circuit board that is configured to electrically connect the chip 16 and the sensor 18. The construction of a card with a biometric sensor in the form of a fingerprint sensor and an integrated circuit chip is known from US 20190102662 and US 20190377855, the entire contents of which are incorporated herein by reference.

As described above, the biometric sensor 18 can be any type of biometric sensor that can sense or detect a biometric feature which can be a biometric feature of the intended cardholder or a biometric feature of someone other than the intended cardholder. In some embodiments, the biometric sensor 18 can be configured as a capacitive sensing element, an optical sensing element, or a thermal sensing element. In one embodiment, the biometric sensor 18 can be a fingerprint sensor that detects a fingerprint. The fingerprint can be of any finger of the intended cardholder including the cardholder's thumb, index finger, middle finger, ring finger or pinky finger. In operational use, the card 10 stores a sample of the biometric feature, for example in storage in the integrated circuit chip 16. For example, the integrated circuit chip 16 can store the cardholder's fingerprint or other biometric feature of the cardholder. A biometric feature that is read/sensed/detected by the biometric sensor 18 during use of the card 10 is then compared with the stored biometric feature to determine a match. In the case of a credit card, if there is a match, a purchase that the cardholder is trying to make using the card can be authorized. If there is not a match, the purchase can be denied.

With continued reference to FIG. 1, the card 10 may optionally include a magnetic stripe 20 that is capable of storing data thereon. The construction and operation of a magnetic stripe on a card is well known in the art. In the example illustrated in FIG. 1, the magnetic stripe 20 is depicted as being located on the rear surface of the card 10. However, the magnetic stripe 20 (if present) can be located on the front surface 12.

The card 10 also typically includes additional features such as the printed data 22. The printed data 22 may include personal printed data that is personal to the intended card holder, including a personal account number, the card holder's name, a photograph of the intended card holder, an address, an expiration date, and other personal data known in the art. The printed data 22 may also include non-personal printed data such as a name and/or logo of the card issuer, name and/or logo of a bank, and graphical elements. The printed data 22 can be located on the front surface 12 as depicted in FIG. 1 and/or on the rear surface. The printed data 22 can be printed with an ink or a dye, and/or the printed data 22 can be markings generated on the card 10 using a laser.

Prior to being issued to the intended cardholder, the card 10 is processed in a plastic card processing system. The plastic card processing system tests the chip 16 to determine whether or not the chip 16 is functioning properly and/or programs data on the chip 16 and/or reads data from the chip 16. In addition, the plastic card processing system tests the biometric sensor 18 to determine whether or not the sensor 18 is functioning properly. Further, the plastic card processing system may read/write data from/to the magnetic stripe 20 (if present), print the data 22, emboss one or more characters on the card, indent one or more characters on the card, applying a laminate to the card, apply a topcoat to the card, apply a security feature to the card, and perform other processing.

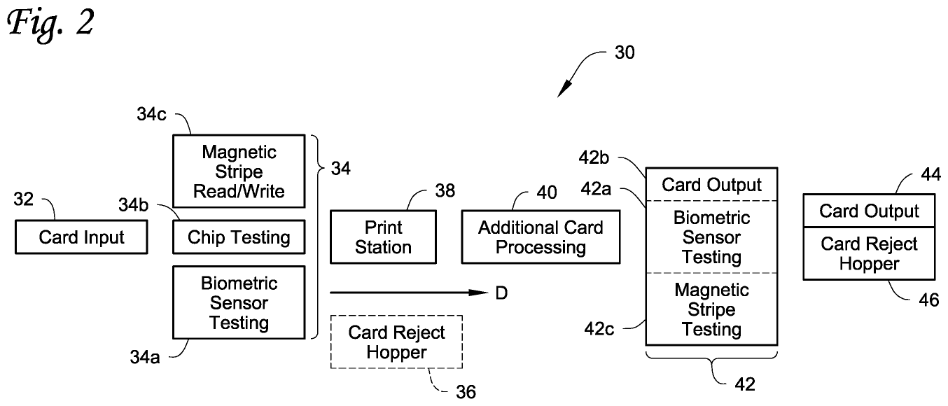

FIG. 2 is a schematic depiction of one embodiment of a card processing system 30 described herein that is configured to process one or more cards. The system 30 is configured to at least perform functionality testing of the biometric sensor on the plastic card. In some embodiments, the system 30 can be configured to perform additional processing on the card in addition to functionality testing of the biometric sensor. The system 30 in FIG. 2 can include a card input 32, one or more testing stations 34 downstream from the card input 32, an optional card reject hopper 36, a print station 38, one or more additional card processing stations 40, one or more testing stations 42, a card output 44 and a card reject hopper 46.

The card input 32 can be configured to hold a plurality of plastic cards waiting to be processed and that mechanically feeds the plastic cards one by one into the system 30 using a suitable card feeder. In this configuration, the card input 32 is often termed a card input hopper. The construction and operation of card inputs and card input hoppers is well known in the art. The card input 32 can be configured with a multihopper configuration where the card input 32 is configured to simultaneously hold different card stock (for example, Visa® and Mastercard® branded card stock; driver's license card stock from different states; identification card stock having different security levels; etc.) waiting to be processed. Each type of card stock can be selectively input into the system 30 as selected by the system controller based on the type of card to be created. In another embodiment, the card input 32 can be configured as an input slot that permits cards to be manually fed one by one into the system 30.

The cards are initially introduced into the one or more testing stations 34 which tests the functionality of the cards prior to further processing. If any card is not functioning properly, the card can be transported to the optional card reject hopper 36 (if provided) or transported to the card reject hopper 46.

The one or more testing stations 34 can include a biometric sensor testing device 34a that is configured to test functionality of the biometric sensor 18 on the plastic cards. Testing the functionality can include testing the connection between the chip 16 and the sensor 18 (for example, is the biometric sensor 18 receiving power from the chip 16) and/or testing whether or not the sensing function of the biometric sensor 18 is working properly (for example, is the biometric sensor 18 capable of sensing a biometric feature).

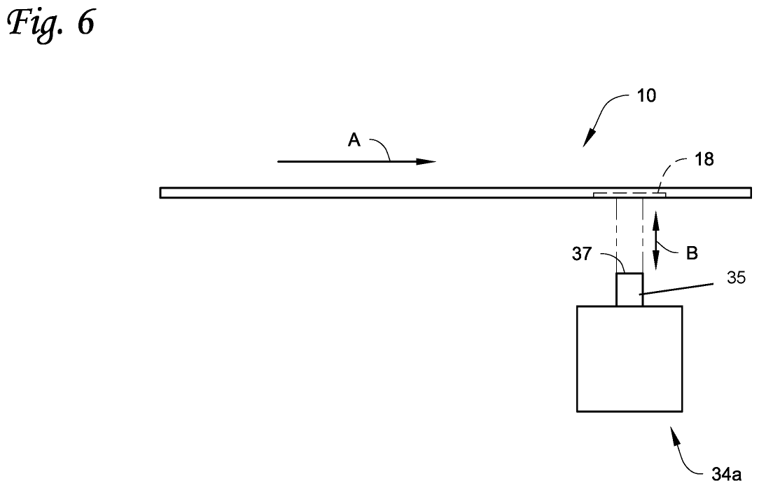

The biometric sensor testing device 34a can have any mechanical configuration that is suitable to test the operability of the biometric sensor 18. For example, with reference to FIG. 6, the card 10 can be transported in the direction of the arrow A into position relative to the biometric sensor testing device 34a. The biometric sensor testing device 34a can include a probe 35 that is actuatable toward and away from the card 10 in the direction of the arrow B between a retracted position (solid lines) where an end 37 of the probe 35 is spaced from the card and an activate position (broken lines) where the end 37 of the probe 35 is positioned either engaged with the biometric sensor on the card 10 or is otherwise suitably positioned relative to the biometric sensor to be read by the biometric sensor. Other mechanical constructions of the testing device 34a are possible and intended to be covered in this patent application. Where the biometric sensor is a fingerprint sensor, the end 37 of the probe 35 may directly contact the biometric sensor and the end 37 can be configured in any suitable manner to test the biometric sensor 18. For example, in one embodiment, the end 37 of the probe 35 can include a test pattern that can be read by the biometric sensor 18. In one embodiment, the test pattern can be a pattern of lines that does not replicate an actual fingerprint but where the pattern of lines can still be read by the biometric sensor to test the sensor. In another embodiment, the test pattern can be a pattern of lines that replicate a fingerprint. The test pattern may be formed by, for example, a rubber stamp in which a plurality of lines are created for the sensor to read. The test pattern can be formed or provided in any other manner as long as the test pattern can be read by the sensor. The end 37 may apply pressure and possibly heat to the fingerprint sensor to more closely simulate an actual fingertip. The end 37 of the probe need not contact the biometric sensor depending upon the type of biometric sensor used.

In the example of the biometric sensor being a fingerprint sensor, since the primary purpose of the biometric sensor testing device 34a is to test the functionality of the biometric sensor 18, the use of a test pattern, whether replicating a fingerprint or a pattern of lines that does not replicate a fingerprint, for testing purposes is acceptable. To test the sensor, an internal diagnostic test can be invoked during which the data from the test pattern read by the sensor 18 is compared to the stored data of the expected test pattern on the probe 35. During the test, operation of the biometric sensor 18 can be activated in a manner known in conventional card fingerprint sensors, for example using power from the integrated circuit chip or other power source. Once the end 37 of the probe 35 is suitably positioned, the biometric sensor 18 then attempts to read the test pattern on the end 37 of the probe 35. If the biometric sensor 18 is unable to read the test pattern, that can indicate a potential problem with the biometric sensor 18. If the biometric sensor 18 is able to read the test pattern, the data corresponding to the read test pattern can be compared to stored data (either on the card or stored off of the card) of the expected test pattern. That comparison can also indicate the level of operability of the biometric sensor 18. In some embodiments, it is possible that the test pattern at the end 37 of the probe 35 could be or replicate an actual fingerprint of the intended card holder in which case the fingerprint pattern at the end 37 of the probe 35 changes from one card to the next card.

Returning to FIG. 2, the one or more testing stations 34 can also include a chip testing device 34b that is configured to perform contact or contactless testing on the chip 16 to test the functionality of the chip 16. Testing the functionality of the chip 16 can include reading data from and/or writing data to the chip 16. In one embodiment, fingerprint data relating to the intended cardholder can be written the chip 16 by the device 34b either before or after testing of the biometric sensor. The construction and operation of chip testing devices in card processing systems is well known in the art.

The one or more testing stations 34 can also include a magnetic stripe read/write testing device 34c that is configured to read data from and/or write data to the magnetic stripe 20 if present. The construction and operation of magnetic stripe read/write testing devices in card processing systems is well known in the art.

The testing devices 34a, 34b, 34c can be separate devices or integrated together into a single device. The testing devices 34a, 34b, 34c can also be arranged relative to one another in the system 30 so that the testing devices are spaced from one another along a card transport direction or transport path D of the system 30, or the testing devices can be arranged relative to one another so that some of the testing devices are arrayed transverse to the transport direction/path D as depicted in FIG. 2.

In addition, the testing of the biometric sensor 18 and the testing of the chip 16 (and the testing of the optional magnetic stripe) can occur in any order. For example, operation of the chip 16 can be tested first followed by testing operation of the biometric sensor 18, or testing operation of the biometric sensor 18 can occur first followed by testing operation of the chip 16. In one embodiment, the chip 16 and the biometric sensor 18 can be tested at the same time (what can be considered simultaneously or substantially simultaneously).

Still referring to FIG. 2, the print station 38 is downstream from the testing stations 34. The print station 38 is configured to perform printing on the cards. The print station 38 can be configured to perform any type of printing known in plastic card processing including, but not limited to, drop-on-demand printing and thermal transfer printing.

The one or more additional card processing stations 40 can be stations that are configured to perform any type of additional card processing. Examples of the additional card processing stations 40 include, but are not limited to, an embossing station having an embosser configured to emboss characters on the cards, an indent station having an indenter configured to indent one or more characters on the cards, a laser marking station with a laser configured to perform laser marking on the cards, a lamination station with a laminator configured to apply one or more laminates to the cards, a topcoat station with a topcoat applicator configured to apply a topcoat to one or more of the surfaces of the cards, a security station with a security feature applicator configured to apply a security feature to one or more of the surfaces of the cards, and one or more card reorienting mechanisms/flippers configured to rotate or flip a card 180 degrees for processing on both sides of the cards.

Still referring to FIG. 2, it is possible that the processing on the cards can damage the functioning of the biometric sensor 18, the chip 16 and/or the magnetic stripe 20. Therefore, the one or more testing stations 42 can be provided, for example just upstream of the card output 44 to test the functionality of the chip 16, the functionality of the sensor 18 and/or the functionality of the magnetic stripe 20 prior to outputting the cards to the output 44. The one or more testing stations 42 can also test the chip 16 and the magnetic stripe 20 to verify that the correct data has been programmed on the chip 16 and written to the magnetic stripe 20 by reading data from the chip 16 and/or the magnetic stripe 20 and comparing the read data with data one is expecting. The testing stations 42 can be part of what can be considered a quality assurance mechanism to test the quality of the card processing that occurs. The testing stations 42 can also include a machine vision station with a camera that is used to visually confirm the quality of the card processing. The use of machine vision in a quality assurance mechanism is known from U.S. Pat. No. 9,275,259 the entire contents of which are incorporated herein by reference. Any cards that are determined to be deficient can be directed into the card reject hopper 46.

In the illustrated example, the one or more testing stations 42 include a biometric sensor testing device 42a, a chip testing device 42b, and a magnetic stripe read/write testing device 42c. The testing devices 42a, 42b, 42c can function similarly to the testing devices 34a, 34b, 34c, and they can have similar constructions. In some embodiments, only the testing stations 42 can be provided in the system 30 and the testing stations 34 are not provided. In other embodiments, only the testing stations 34 are provided in the system 30 and the testing stations 42 are not provided.

The card output 44 can be configured to hold a plurality of plastic cards after they have been processed. In this configuration, the card output 44 is often termed a card output hopper. The construction and operation of card output hoppers is well known in the art. Like the card input 32, the card output 44 can also be configured with a multihopper configuration where the card output 44 is configured to simultaneously hold different card stock (for example, Visa® and Mastercard® branded card stock; driver's license card stock from different states; identification card stock having different security levels; etc.) after they have been processed. Each type of card stock can be selectively output from the system 30 as selected by the system controller based on the type of card that has been processed. In another embodiment, the card output 44 can be configured as an output slot from which the processed cards are discharged one by one from the system 30.

The type of system illustrated in FIG. 2 is a large volume batch production card processing system (or central issuance processing system) that processes cards in high volumes, for example on the order of high hundreds or thousands per hour, employ multiple processing stations or modules to process multiple cards at the same time to reduce the overall per card processing time. Examples of such large volume card processing machines include the MX and MPR family of central issuance processing machines available from Entrust Datacard Corporation of Shakopee, Minn. Other examples of central issuance processing machines are disclosed in U.S. Pat. Nos. 4,825,054, 5,266,781, 6,783,067, and 6,902,107, all of which are incorporated herein by reference in their entirety.

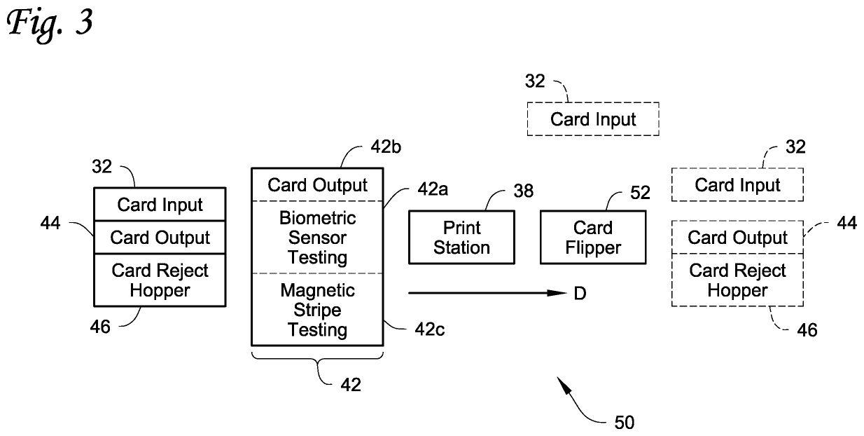

FIG. 3 is a schematic depiction of another example of a card processing system 50 described herein that is configured to process one or more cards performing functionality testing of the biometric sensor on the plastic card. The system 50 in FIG. 3 is configured as a desktop card processing system that is typically designed for relatively smaller scale, individual card personalization in relatively small volumes, for example measured in tens or low hundreds per hour, often times with a single card being processed at any one time. These card processing machines are often termed desktop processing machines because they have a relatively small footprint intended to permit the processing machine to reside on a desktop. Many examples of desktop processing machines are known, such as the SD or CD family of desktop card printers available from Entrust Datacard Corporation of Shakopee, Minn. Other examples of desktop processing machines are disclosed in U.S. Pat. Nos. 7,434,728 and 7,398,972, each of which is incorporated herein by reference in its entirety.

In FIG. 3, elements that are similar in construction or functionality to elements in the system 30 in FIG. 2 are referred to using the same reference numerals. In FIG. 3, the system 50 is illustrated as including the card input 32, the card output 44 and the card reject hopper 46 at one end of the system 50. Each card is initially functionality tested in the testing stations 42 and if the card is functioning correctly, the card is input into the print station 38. If dual-sided printing is required, the card can be directed into a card flipper 52 which flips the card 180 degrees and the card is then transported back to the print station 38 to print on the other side of the card. The functionality of the card can then again be tested in the testing stations 42 and/or the quality of the processing confirmed before outputting the card to the output 44. In some embodiments, the system 50 may also include a lamination station that applies a laminate to the card. The system 50 may also include any additional card processing stations including card processing stations similar to those used in the system 30.

In the type of system depicted in FIG. 3, the card input 32 and/or the card output 44 can be provided at other locations in the system 50. For example, in one embodiment, the card input 32 can be located at a position higher up in the system, for example at the top of the system above the transport path D between the ends of the system 50 as depicted in dashed lines. In this embodiment, the card output 44 can be located at either end of the system 50. In another embodiment as depicted in dashed lines in FIG. 3, the card input 32, the card output 44 and the reject hopper 46 can be located at the opposite end of the system 50.

In the systems 30, 50 in FIGS. 2 and 3, the cards can be transported throughout the systems 30, 50 and moved along the card transport path D by one or more suitable mechanical card transport mechanisms (not shown). Mechanical card transport mechanism(s) for transporting cards in card processing equipment of the type described herein are well known in the art. Examples of mechanical card transport mechanisms that could be used are known in the art and include, but are not limited to, transport rollers, transport belts (with tabs and/or without tabs), vacuum transport mechanisms, transport carriages, and the like and combinations thereof. Card transport mechanisms are well known in the art including those disclosed in U.S. Pat. Nos. 6,902,107, 5,837,991, 6,131,817, and 4,995,501 and U.S. Published Application No. 2007/0187870, each of which is incorporated herein by reference in its entirety. A person of ordinary skill in the art would readily understand the type(s) of card transport mechanisms that could be used, as well as the construction and operation of such card transport mechanisms.

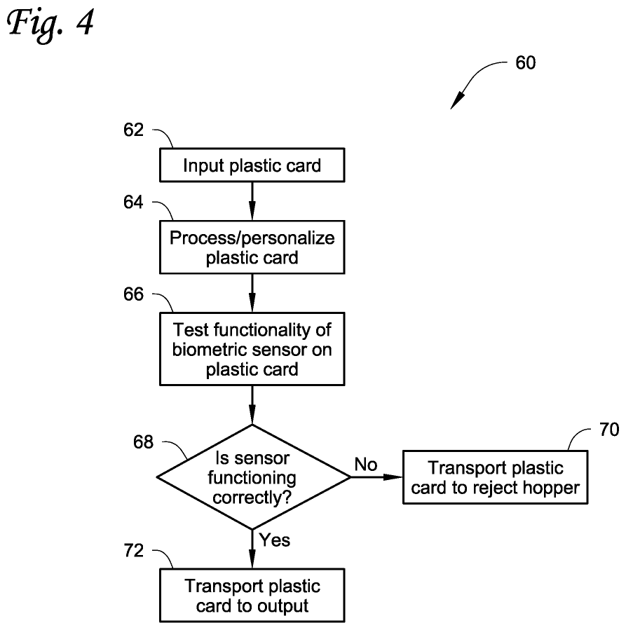

FIG. 4 depicts one embodiment of a method 60 of testing the functionality of a biometric sensor on a plastic card as described herein. In the method 60, a card is input 62 and the card is then processed at 64. After the card is processed, the functionality of the biometric sensor is then tested at 66. Prior to, during, or after the functionality testing at 66, the functionality of the integrated circuit chip can also be tested. A decision is then made at 68, for example by the system controller, whether or not the biometric sensor is functioning correctly. If the decision at 68 is no, then the card is transported to the reject hopper at 70. The system controller may also direct the system to generate a new/replacement card for the defective card. In addition, the card can alternatively be transported to the card output and output directly to the person operating the system. On the other hand, if the decision at 68 is yes, then the card is transported to the card output at 72.

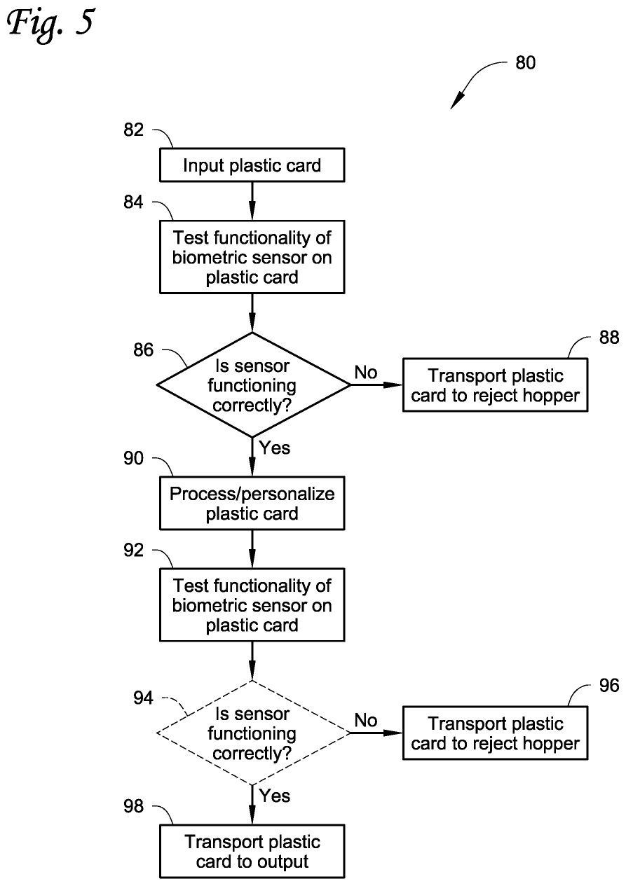

FIG. 5 depicts another embodiment of a method 80 of testing the functionality of a biometric sensor on a plastic card as described herein. In the method 80, a card is input 82 and the functionality of the biometric sensor is then tested at 84. Prior to, during, or after the functionality testing at 84, the functionality of the integrated circuit chip can also be tested. A decision is then made at 86, for example by the system controller, whether or not the biometric sensor is functioning correctly. If the decision at 86 is no, then the card is transported to the reject hopper at 88. The system controller may also direct the system to generate a new/replacement card for the defective card. In addition, the card can alternatively be transported to the card output and output directly to the person operating the system. On the other hand, if the decision at 88 is yes, then the card is processed at 90 by the various processing stations.

Still referring to FIG. 5, after the card is processed, the functionality of the biometric sensor is tested at 92. The functionality can be tested by the same testing station as step 84 or by a different testing station. As before, prior to, during, or after the functionality testing at 92, the functionality of the integrated circuit chip can also be tested. A decision is then made at 94, for example by the system controller, whether or not the biometric sensor is functioning correctly. If the decision at 94 is no, then the card is transported to the reject hopper at 96. The system controller may also direct the system to generate a new/replacement card for the defective card. In addition, the card can alternatively be transported to the card output and output directly to the person operating the system. On the other hand, if the decision at 94 is yes, then the card is transported to the card output at 98.

The card processing systems and methods described herein can utilize a single biometric sensor testing station or two or more biometric sensor testing stations. In addition, the functionality testing of the biometric sensor described herein can occur in conjunction with functionality testing of the integrated circuit chip or without corresponding functionality testing of the integrated circuit chip. In addition, functionality testing of either one of the integrated circuit chip or the biometric sensor could occur prior to card processing while the functionality testing of the other one of the integrated circuit chip or the biometric sensor could occur after the card processing.

In addition, functionality testing of the biometric sensor could occur anywhere in the card processing system. For example, the functionality testing could occur immediately after a processing operation that one determines has a high chance of damaging the functionality of the biometric sensor, followed thereafter by one or more additional card processing operations considered less likely to damage the functionality of the biometric sensor. In addition, the functionality testing of the biometric sensor could occur any number of times in the system, for example 2 times or 3 or more times.

In addition, a system that employs the functionality testing of the biometric sensor and integrated circuit chip described herein could be configured without any additional card processing stations whereby the system only tests the functionality and immediately outputs the card(s) without performing any other card processing before or after the functionality testing. In such an embodiment, the system could be referred to as a stand-alone functionality testing system or as a stand-alone quality assurance system.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method comprising:
inputting a plastic card into a plastic card processing system, the plastic card having at least one biometric sensor; and
with the plastic card in the plastic card processing system, testing functionality of the at least one biometric sensor.

2. The method of claim 1, wherein the plastic card further includes at least one integrated circuit chip that is electrically connected to the at least one biometric sensor; and further comprising testing functionality of the at least one integrated circuit chip.

3. The method of claim 2, comprising testing the functionality of the at least one integrated circuit chip before or after testing the functionality of the at least one biometric sensor.

4. The method of claim 2, comprising testing the functionality of the at least one integrated circuit chip at the same time as testing the functionality of the at least one biometric sensor.

5. The method of claim 2, comprising testing the functionality of the at least one integrated circuit chip using a chip testing device, and testing the functionality of the at least one biometric sensor using a biometric sensor testing device.

6. The method of claim 1, wherein the at least one biometric sensor comprises a fingerprint sensor or an iris sensor.

7. The method of claim 1, further comprising:
after testing the functionality of the at least one biometric sensor, transporting the plastic card to an output or into a reject hopper.

8. The method of claim 1, further comprising one or more of the following:
reading data from and/or writing data to a magnetic stripe on the plastic card in a read/write station;
printing on the plastic card in a print station;
embossing a character on the plastic card in an embossing station;
indenting a character on the plastic card in an indent station;
creating a mark on the plastic card with a laser in a laser marking station;
applying a laminate to the plastic card in a lamination station;
applying a topcoat to the plastic card in a topcoat station;
applying a security feature to the plastic card in a security station.

9. A method comprising:
inputting a plastic card into a plastic card processing system, the plastic card having at least one biometric sensor and at least one integrated circuit chip that is electrically connected to the at least one biometric sensor;
with the plastic card in the plastic card processing system, testing functionality of the at least one biometric sensor using electrical power supplied from the at least one integrated circuit chip;
after testing functionality of the at least one biometric sensor, transporting the plastic card to an output or to a reject hopper.

10. The method of claim 9, further comprising one or more of the following:
reading data from and/or writing data to a magnetic stripe on the plastic card in a read/write station;
printing on the plastic card in a print station;
embossing a character on the plastic card in an embossing station;
indenting a character on the plastic card in an indent station;
creating a mark on the plastic card with a laser in a laser marking station;
applying a laminate to the plastic card in a lamination station;
applying a topcoat to the plastic card in a topcoat station;
applying a security feature to the plastic card in a security station.

11. A plastic card processing system, comprising:
a biometric sensor testing device that is configured to test functionality of at least one biometric sensor on a plastic card in the plastic card processing system.

12. The plastic card processing system of claim 11, further comprising:
a card input that is configured to hold a plurality of the plastic cards and feed the plastic cards one by one into the plastic card processing system, each plastic card having at least one biometric sensor;
a card output that is configured to hold a plurality of plastic cards;
one or more card transport mechanisms that interconnect the card input, the biometric sensor testing device, and the card output.

13. The plastic card processing system of claim 12, wherein each one of the plastic cards further includes at least one integrated circuit chip that is electrically connected to the at least one biometric sensor; and further comprising a chip testing device that is configured to test functionality of the at least one integrated circuit chip on the plastic cards.

14. The plastic card processing system of claim 11, wherein the biometric sensor testing device is configured as a fingerprint testing device or an iris testing device.

15. The plastic card processing system of claim 13, wherein the chip testing device is configured to perform contact testing on the at least one integrated circuit chip or perform contactless testing on the at least one integrated circuit chip.

16. The plastic card processing system of claim 12, further comprising a reject hopper.

17. The plastic card processing system of claim 13, wherein the chip testing device and the biometric sensor testing device are located between the card input and the card output.

18. The plastic card processing system of claim 13, wherein the chip testing device and the biometric sensor testing device are located downstream from both the card input and the card output.

19. The plastic card processing system of claim 12, further comprising one or more of the following:
a magnetic stripe read/write station having a magnetic stripe read/write device;
a print station having a print head;
an embossing station having an embosser;
an indent station having an indenter;
a laser marking station with a laser;
a lamination station with a laminator;
a topcoat station with a topcoat applicator;
a security station with a security feature applicator.
